(19) United States
(12) Patent Application Publication
(10) Pub. No.: US 2017/0307797 A1
(43) Pub. Date: Oct. 26, 2017

(54) VEHICLE CAMERA WITH LOW PASS FILTER

(71) Applicant: MAGNA ELECTRONICS INC., Auburn Hills, MI (US)

(72) Inventor: Thomas Wierich, Butzbach (DE)

(21) Appl. No.: 15/490,172

(22) Filed: Apr. 18, 2017

Related U.S. Application Data
(60) Provisional application No. 62/325,702, filed on Apr. 21, 2016.

(51) Int. Cl. G02B 5/32; G03H 1/02; G03H 1/24; G08G 1/16; G02B 5/20; B60R 1/12; H04N 5/225; B60R 1/06; B60R 1/04

(52) U.S. Cl. CPC G02B 5/32; B60R 1/12; G03H 1/0248; G03H 1/24; G08G 1/166; G08G 1/167; G02B 5/208; B60K 2350/106; B60R 2300/303; B60R 2300/105; B60R 2001/1253; B60R 1/06; B60R 1/04; B60K 2350/927; B60K 2350/2026; B60K 2350/2013; B60K 2350/1088; B60R 2300/8033; B60R 2300/804; B60R 2300/8066; B60R 2300/8086; B60R 2300/8093; H04N 5/2254; B60R 2300/607

(57) ABSTRACT

A vision system for a vehicle includes a camera disposed at a vehicle and having a field of view exterior of the vehicle. The camera includes a lens and a pixelated imaging array having a plurality of photosensing elements. The camera includes a volume hologram disposed between the lens and the imaging array. The volume hologram may function as a spatial low pass filter with a steep filtering slope. An image processor is operable to process image data captured by the camera.

### CROSS REFERENCE TO RELATED APPLICATION

The present application claims the filing benefits of U.S. provisional application Ser. No. 62/325,702, filed Apr. 21, 2016, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a driver assistance system or vision system or imaging system for a vehicle that utilizes one or more cameras (preferably one or more CMOS cameras) to capture image data representative of images exterior of the vehicle, with the camera comprising a spatial low pass filter with a steep filtering slope. Advantageously, a small thickness and low price can be achieved. The volume hologram is preferably applied on a foil to fulfil these requirements.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is an MTF diagram of an ideal filter slope A, a conventional Quartz-crystal-filter slope B, and a steep filter slope C of a volume hologram in accordance of the present invention, with the spatial frequency axis plotted linearly; and

FIG. 3 is a schematic of an automotive fish eye camera with a fish eye lens stack, an infrared (IR) filter, a spatial low pass filter comprising a volume hologram, a pixel lens array (2D), a Bayer color filter array, and a 2D light sensitive array (image sensor).

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

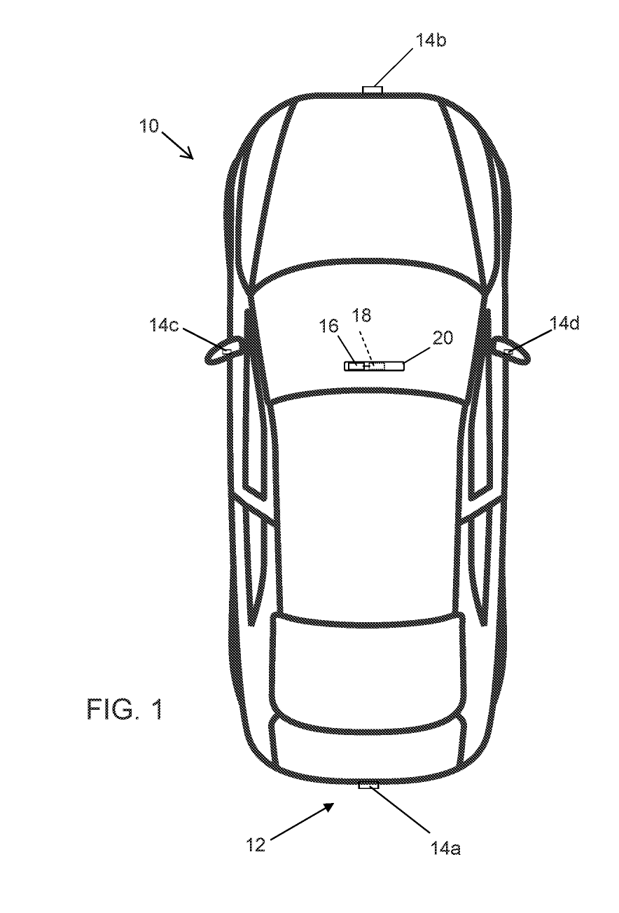

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forward facing camera 14b at the front (or at the windshield) of the vehicle, and a sideward/rearward facing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Typically, digital cameras, especially automotive cameras, comprise an imager which has an array of light sensitive pixels, a lens system and image processing electronics. The lens system of a (typically RGB) vehicle camera has optical filters in the frequency domain such as infrared (IR) blocking low pass filters. The imager pixels have a band pass for a specific light color such as red, green and blue (Bayer filter). In most near infrared (NIR) night vision imagers, the pixels have a band pass for near infrared light.

Digital cameras additionally possess low pass filters in the spatial domain. The purpose of the spatial filter is to filter higher frequencies than the pixel resolution can resolve. Since the Nyquist frequency is lower, there is a low pass, otherwise spatial frequency artifacts would be visible in the digital image such as a Moiré pattern.

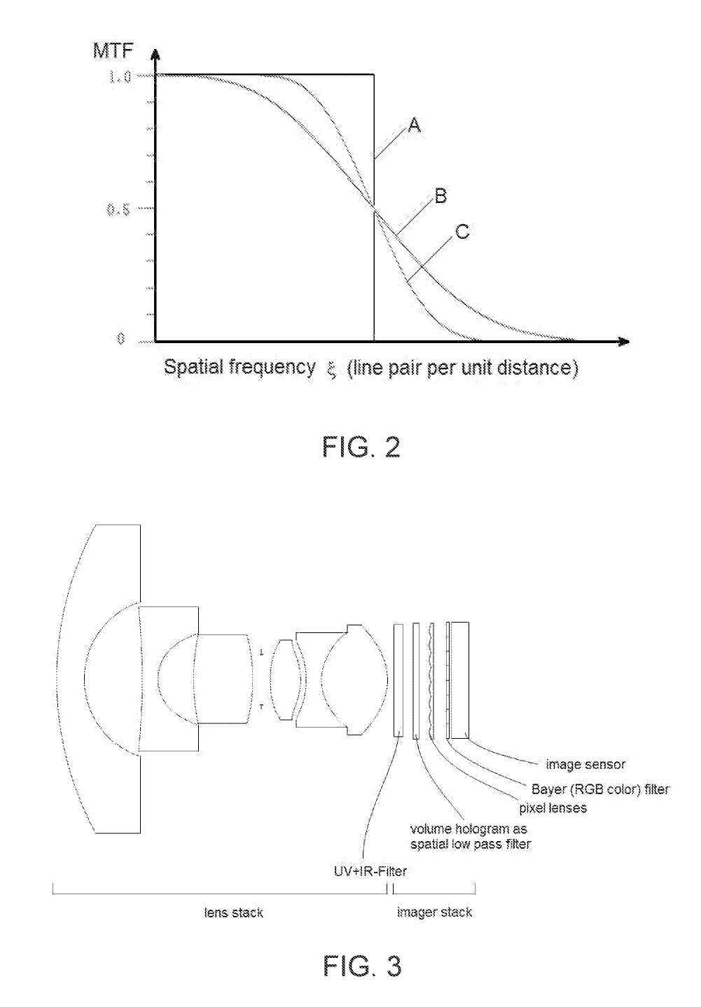

Optionally, quartz crystal low pass filters, which are crystals refracting on both sides, may be used. The refraction is proportional to the crystal's thickness. Typically, these filters are applied onto the imager's cover glass or the filter is the cover glass itself. The filter slope of quartz low pass filters is not very sharp. Filter slopes not much higher than first order can be achieved by using quartz [crystal] low pass filters, see curve B in the Modulation Transfer Function (MTF) diagram of FIG. 2.

The present invention provides a spatial low pass filter with a steep filtering slope, such as a couple hundred η or thereabouts, such as shown by curve C in the MTF diagram of FIG. 2. Curve A of the MTF diagram of FIG. 2 shows a theoretically ideal filter slope curve. Additionally, a small thickness and low price is achieved and is advantageous. Volume holograms, preferably applied on a foil, can fulfil these requirements. The system uses a spatial filter for camera lens-imager systems. All colors pass the volume hologram unchanged, just the spatial frequencies get filtered. A volume hologram is a hologram where the thickness of the recording material is much larger than the light wavelength used for recording. Diffraction of light from the hologram is possible only as Bragg diffraction, i.e., the light has to have the right wavelength (color) and the wave must have the right shape (such as beam direction and wavefront profile), in order to pass through the volume hologram. Thus, the volume hologram can provide a much sharper or steeper cutoff at the desired spatial frequency (compare curve C to curve B of the MTF diagram of FIG. 2).

In DE 102011107093 A1, the use of a two phase hologram for improving the spatial frequency resolution of the pixel colors is suggested. In opposition to that, a volume hologram is a spatial frequency filter for white light. Only volume holograms can be white light holograms, since, due to the Bragg condition, a selective interference of the light's wavelengths takes place instead. A volume hologram can give a reconstructed beam using white light, as the hologram structure effectively filters out colors other than those equal to or very close to the color of the laser used to make the hologram, so that the reconstructed image will appear to be approximately the same color as the laser light used to create the holographic recording.

By that the suggested solution of the present invention is different and advanced as a cost efficient low pass filter solution in the spatial domain.

An example of using a volume hologram as a spatial low pass filter in an automotive (fisheye) camera assembly according the invention is shown in FIG. 3. As shown in FIG. 3, the low pass filter may be disposed between the lens system and the imager system. Optionally, the volume hologram may be incorporated in or attached to the imager stack. Optionally, the imager stack may comprise a two dimensional (2D) pixel lens array, a Bayer color filter array and a 2D light sensitive array with a volume hologram as a spatial low pass filter on top, and optionally an infrared (IR) filter and optionally an UV filter incorporate or on top. Optionally, the IR and/or UV filter and/or the volume hologram as spatial low pass filter may be attached or applied to the imager stack's cover glass. Optionally, the IR filter and/or the UV filter and/or the volume hologram as spatial low pass filter may be may be part of the lens stack. Optionally, the characteristic spatial frequency of the volume hologram low pass filter may be chosen in a way to match to the Nyquist threshold frequency of the sensing system (the imager).

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EyeQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. Pat. No. 9,126,525, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252 and/or 6,642,851, and/or U.S. Publication Nos. US-2012-0162427; US-2006-0050018 and/or US-2006-0061008, which are all hereby incorporated herein by reference in their entireties. Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system for a vehicle, said vision system comprising:
a camera disposed at a vehicle and having a field of view exterior of the vehicle;
wherein said camera comprises a lens and a pixelated imaging array having a plurality of photosensing elements;
wherein said camera comprises a volume hologram disposed between said lens and said imaging array; and
an image processor operable to process image data captured by said camera.

2. The vision system of claim 1, wherein said volume hologram functions as a spatial low pass filter.

3. The vision system of claim 2, wherein said spatial low pass filter has a steep filtering slope.

4. The vision system of claim 1, wherein said volume hologram provides a spatial frequency filter for white light.

5. The vision system of claim 1, wherein said volume hologram is applied on a foil.

6. The vision system of claim 1, wherein said volume hologram is attached or applied to the imager stack's cover glass.

7. The vision system of claim 1, wherein an infrared filter is disposed between said lens and said volume hologram.

8. The vision system of claim 1, wherein a two dimensional lens array is disposed between said volume hologram and said imaging array.

9. The vision system of claim 1, wherein a spectral filter is disposed between said volume hologram and said imaging array.

10. The vision system of claim 1, wherein said volume hologram provides a reconstructed beam using white light.

11. The vision system of claim 10, wherein said volume hologram effectively filters out colors other than those equal to or very close to the color of the laser used to make the hologram.

12. The vision system of claim 11, wherein the reconstructed beam will appear to be approximately the same color as the laser light used to create the hologram.

13. A vision system for a vehicle, said vision system comprising:
a camera disposed at a vehicle and having a field of view exterior of the vehicle;
wherein said camera comprises a lens and a pixelated imaging array having a plurality of photosensing elements;
wherein said camera comprises a volume hologram disposed between said lens and said imaging array;
wherein said volume hologram functions as a spatial low pass filter having a steep filtering slope;
wherein said volume hologram provides a reconstructed beam using white light; and
an image processor operable to process image data captured by said camera.

14. The vision system of claim 13, wherein said volume hologram provides a spatial frequency filter for white light.

15. The vision system of claim 13, wherein said volume hologram effectively filters out colors other than those equal to or very close to the color of the laser used to make the hologram.

16. The vision system of claim 15, wherein the reconstructed beam will appear to be approximately the same color as the laser light used to create the hologram.

17. A vision system for a vehicle, said vision system comprising:
a camera disposed at a vehicle and having a field of view exterior of the vehicle;
wherein said camera comprises a lens and a pixelated imaging array having a plurality of photosensing elements;
wherein said camera comprises a volume hologram disposed between said lens and said imaging array;
wherein an infrared filter is disposed between said lens and said volume hologram;
wherein a two dimensional lens array is disposed between said volume hologram and said imaging array;
wherein a spectral filter is disposed between said lens array and said imaging array; and
an image processor operable to process image data captured by said camera.

18. The vision system of claim 17, wherein said volume hologram functions as a spatial low pass filter having a steep filtering slope, and wherein said volume hologram provides a spatial frequency filter for white light.

19. The vision system of claim 17, wherein said volume hologram is applied on a foil.

20. The vision system of claim 17, wherein said volume hologram is attached or applied to the imager stack's cover glass.
